(19) United States
(12) Patent Application Publication
(10) Pub. No.: US 2014/0189491 A1
(43) Pub. Date: Jul. 3, 2014

(54) VISUAL CROSS-BROWSER LAYOUT TESTING METHOD AND SYSTEM THEREFOR

(71) Applicant: BROWSERBITE OÜ, Tallinn (EE)

(72) Inventors: Tõnis Saar, Tallinn (EE); Kaspar Loog, Tallinn (EE); Marti Kaljuve, Tallinn (EE)

(73) Assignee: BROWSERBITE OÜ, Tallinn (EE)

(21) Appl. No.: 13/733,530

(22) Filed: Jan. 3, 2013

(51) Int. Cl. G06F 17/22

(52) U.S. Cl. CPC G06F 17/2247
USPC 715/234

(57) ABSTRACT

According to the invented method, web pages are rendered on virtual PC's using different combinations of operating systems and browsers. Rendered web pages are stored as digital color images. For each picture a specific set of features are calculated and compared against the feature of a baseline image. Regions containing differences are marked and stored. Detected differences are displayed as transparent windows on top of browser under test. Transparent windows are sections of baseline browser images. These sections comprise regions where feature error threshold has been exceeded.

### TECHNICAL FIELD

The present invention relate to testing Internet resources, such as web pages and web applications, and more specifically to automating visual testing of software applications.

### BACKGROUND ART

Users have a variety of web browsers and respective versions of browsers to choose amongst when accessing internet resources (e.g., web pages, web applications, etc.). Web pages and applications are designed to work cross platform compatibly on all browsers and respective versions of browsers and operating system configurations. But still, different browsers on different operating systems tend to interpret and render such internet resources differently, thus causing rendering inconsistencies. For example, one web browser may render an image within a web page at a different position than another web browser. To make matters worse, rendering inconsistencies may be caused by differences amongst operating systems and other settings.

A developer may spend significant time investigating and eliminating rendering differences between web browsers. The developer may have to render a web page within multiple browsers, versions, and operating systems to detect rendering inconsistencies. Some of these rendering differences are considered to be errors by web users. To detect these differences either manual visual inspection by or document object model data (DOM) based automatic detection is currently being used.

According to manual inspection method, to detect cross-browser differences web developers, testers and administrators have to conduct visual cross-browser compatibility tests. These tests are very time consuming and expensive. In most cases web pages are tested manually by opening pages on different existing web browsers and comparing results either side-by-side or one-by-one. Often errors are very difficult and time consuming to find. Also human vision is very ineffective in finding small differences on big web pages with rich content.

Use of computer vision for visual web testing enables to lower web testing costs and improve testing speed and repeatability.

DOM based solutions use document object model data to compare two web pages on different configurations. Strings inside DOM are being compared. Parameters like absolute position, name etc are compared. Most browsers generate DOM structure with small differences. This causes DOM based systems to generate large number of false positive test results. In addition to that even if DOM structure is correct there is no proof that final rendering result will be identical and error free across all configurations. Only visual testing can provide accurate cross-browser test results.

US patent application to Microsoft, titled US2010/0211893 Cross-browser page visualization presentation describes detection of rendering inconsistencies using DOM. A web page is rendered on at least two browsers. User interface DOM elements are aggregated one-by-one. Comparison is done by comparing two sets of object model data.

A research paper “A Cross-browser Web Application Testing Tool” by Choudhary, Roy Shauvik, Versee, Husayn ja Orso, Alessandro. Timisoara : s.n., 2010. 26th IEEE International Conference on Software Maintenance (ICSM 2010), pp 1-6 describes tool for comparison of structural and visual characteristics of web pages on different browsers. Web pages are rendered on different browsers. From each rendered web page DOM structure is extracted. One of the configurations is considered to be reference set. Each node in reference DOM structure is matched with corresponding node. Attributes of nodes are compared to find differences. In addition to structural analysis visual appearance of HTML elements is compared. Visual analysis is based on histogram calculation. If difference between two image sections exceeds certain threshold then difference is reported.

A paper “Automated Cross-Browser Compatibility Testing” by Yingzi Du, Chein-I Chang, Journal of Electronic Imaging. 2003. a., Volume. 12, 3, proposes cross-browser compatibility based on DOM data. Method is focused on more behavior level differences by observing dynamic part of DOM between web page state transitions. A finite state machine navigation model is constructed for each browser configuration. Comparison of a reference browser model against a browser under test model enables to find potential cross-browser issues.

US patent application US2011/0231823 to Lukas titled Automated visual testing describes automated visual testing method for graphical user interface. First static images (snapshots) of user interface are generated. Then dynamic (time-variant) parts of the images are covered with predefined masks to reduce number of false positives. Images of user interface are compared against predefined patterns. Differences between image and patterns are reported to the user.

This may be considered as closest solution known from the art.

### DISCLOSURE OF THE INVENTION

According to one embodiment of the invented method, web pages are rendered on virtual PC's using different combinations of operating systems and browsers. Rendered web pages are stored as digital color images. For each picture a specific set of features are calculated and compared against the feature of a baseline image (here, baseline image is the image of the web page the user considers as authentic, correct, desired version of the web page).

Regions containing differences (errors, faults) are marked and stored. Detected differences are displayed as transparent windows on top of browser under test. Transparent windows are sections of baseline browser images. These sections contain regions where feature error threshold has been exceeded.

A visual cross-browser testing method for testing web pages and web applications in a computer system is disclosed. The method comprises the steps of providing a baseline image of the web page rendered by a baseline browser; extracting the baseline image features from said baseline image;

providing a test image of the web page rendered by browser under test;
extracting the test image features from said test image;
comparing the baseline image features and the test image features;
marking up the faulty regions of the test image and visualizing the faulty regions on said test image.

The visualizing may comprise representing the faulty regions as transparent sliding window on said test image.

The visualizing may further comprise representing the faulty regions as colored box on said test image.

The steps of extracting features further comprises providing a rendered bitmap image representing the web page, finding the regions of interest of said bitmap image, said regions comprising graphic elements relevant for visual testing, calculating specific set of parameters for each region of interest and saving each region of interest separately.

The step of determining the regions of interest comprises calculating corner features for the image, determining regions comprising a corner, joining neighboring corners into regions of interest and calculating bounding co-ordinates for regions of interest.

The step of calculating features of the region of interest comprises providing the image of region of interest, calculating the size of the region of interest, calculating Hu moments of the image and positioning the image relative to original image.

Another aspect of the invention is a system for cross-browser testing of web pages and web applications, the system comprising:

a web renderer, comprising a plurality of virtual machines, each of said virtual machines adapted to run an operating system and a browser for rendering a test web page and capturing a test image of said test web page;
a comparer for comparing said images captured by said plurality of virtual machines with a baseline image and detecting differences between said test images, and said baseline image; and
a result server for generating a graphical user interface and outputting said differences on said graphical user interface, wherein each of said web renderer, said comparer and said result server connected to each other over a computer network.

Said result server may be adapted to show each of said test images captured by said plurality of virtual machines as thumbnails with differences highlighted compared to said baseline image.

Said result server may be further adapted to show a full size test image with said differences from said baseline image highlighted or transparent or colored boxes.

These embodiments are further described below.

### BRIEF DESCRIPTION OF THE DRAWINGS

FIG. 1 shows one embodiment of the proposed system hardware.

FIG. 2 is a flow chart of the visual cross-browser testing method according to one embodiment of the invention.

FIG. 3 is a flow chart further explaining the step of extracting features according to the invention.

FIG. 4 is a flow chart further explaining the step of determining the regions of interest.

FIG. 5 is a flow chart further explaining the step of calculating the features of the regions of interest.

FIG. 6 illustrates one option of presenting visual differences.

### BEST MODE FOR CARRYING OUT THE INVENTION

The claimed invention is now described with references to enclosed figures.

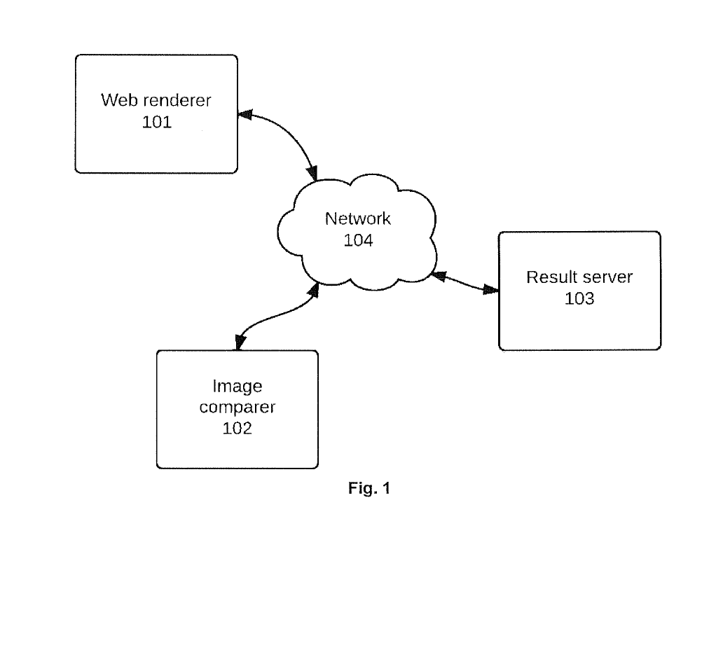

One embodiment of the proposed system hardware is described in FIG. 1. System comprises three nodes: a web renderer 101, an image comparer 102, and a result server 103. Each of these nodes can be either PC, server, processor. Nodes are connected with each other using network 104. Network could be Ethernet, LAN, WAN, etc. For different configurations the browser and the operating system are run on virtual or real node.

Web renderer node could be either virtual or real processing unit. Web page under test is rendered on specific browser and snapshot of full page is saved in data storage. Data storage could be either local (inside node), network attached or cloud based.

The image comparer node could be based on virtual or real processing unit. Processing unit could be PC, server or other processing platform. The image comparer loads static images from a file storage and runs comparison software.

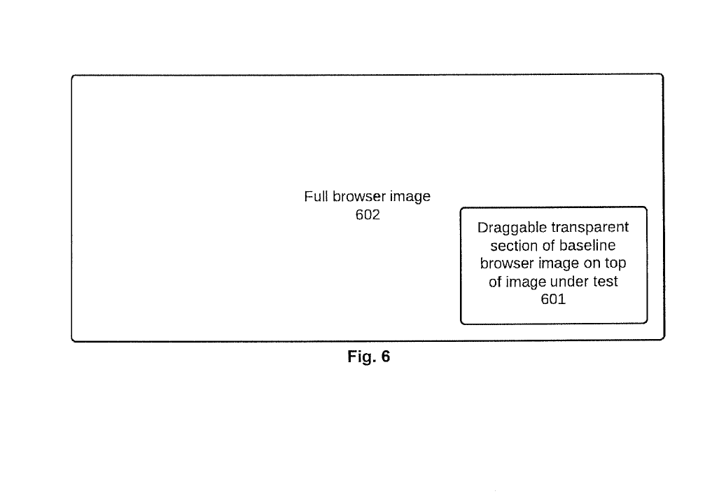

Result server node could be based on virtual or real processing unit. Processing unit could be PC, server or other processing platform. Main task of this unit is to provide a graphic user interface. User can start new tests using this interface. For this purpose a specific web page is hosted. This page displays the test results. Saved images of web pages are displayed as small thumbnails or full size images. As shown on FIG. 6, detected differences (faults, errors) are preferably highlighted using transparent or colored boxes 601 on top of the page under test images 602. Transparent boxes represent small sections of baseline web page image. These boxes are draggable by the user across the display.

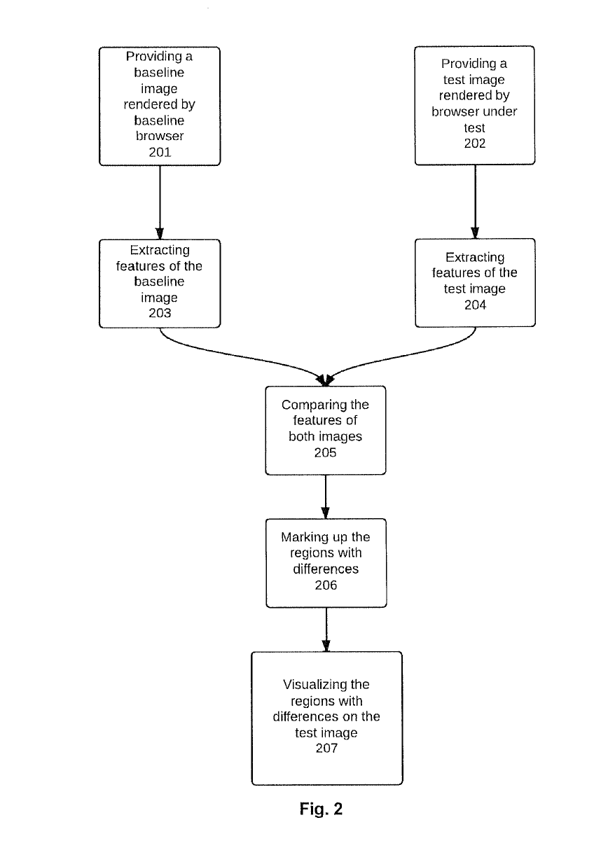

FIG. 2 is a flow chart of the visual cross-browser testing method for testing web pages and web applications in a computer system. The method comprises the steps of providing a baseline image (step 201), i.e. an image rendered by a baseline browser, and providing a test image (step 202), i.e., an image rendered by a browser under test. Both images are rendered and saved on different configurations consisting of web browser and operating system. The method further comprises extracting specific features of the baseline image (step 203) and extracting specific features of the test image (step 204). Steps 201 to 204 can be carried out either sequentially or in parallel. The method further comprises for comparing the features of both images to find the differences on the test image compared to the baseline image (step 205); marking up the regions with differences of the test image (step 206) and visualizing the regions with differences (step 207). Preferably, the visualizing comprises representing the regions with differences as transparent sliding window or colored boxes on a test image.

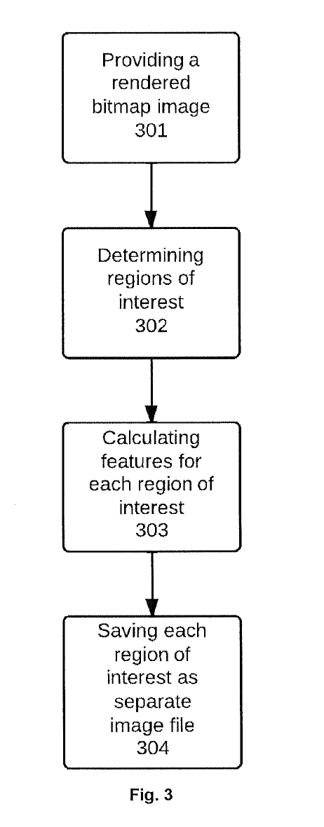

FIG. 3 further explains one embodiment of the step of extracting features (step 203 on FIG. 2), comprising first providing a rendered bitmap image of the web page (step 301), determining the regions of interest (ROI) of said image (step 302). These regions contain graphic elements which are most relevant for visual testing. Based on these ROIs, the image is divided into smaller sections. The method further comprises calculating specific set of parameters for each ROI (step 303) and saving each ROI as separate image file on local or network attached storage.

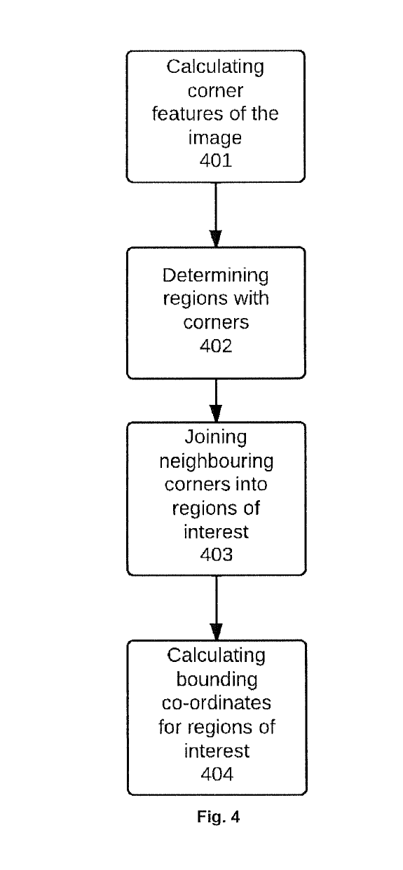

FIG. 4 further explains the step of determining the regions of interest (ROI). The step of determining the regions of interest further comprises the step of calculating the corner features of the image (step 401), determining regions with corners from the corner features (step 402), joining neighboring regions containing corners into regions of interest (step 403) and calculating bounding co-ordinates for ROIs (step 404). In step 401, corner features of the image can be calculated by several known corner detection algorithms, e.g., Movarec, Shi-Tomasi, Harris, or others. Output from corner detection will be compared against dynamic or static value to separate corner pixels from others. Corners that are closely situated will be joined into larger regions. The decision will be based on threshold value which can be either dynamic or static value. This value will define maximum distance between corners. If corners are situated closer than defined threshold then they will be contained into one region called region of interest (ROI). The ROIs usually contain graphical elements of web pages such as buttons, submit boxes, text section, etc.

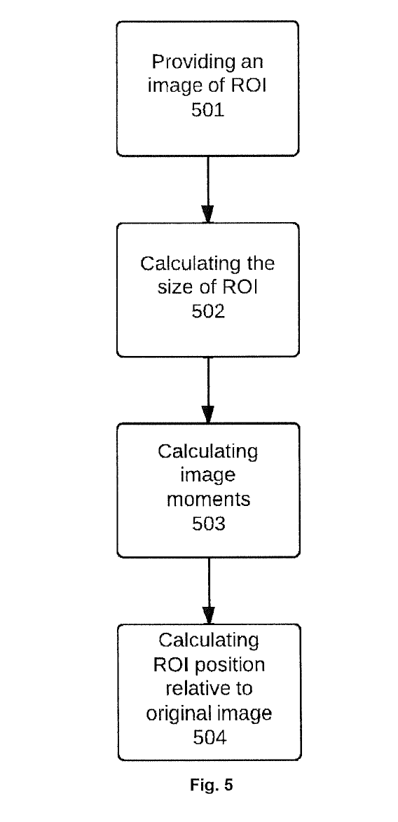

FIG. 5 further explains the step of calculating features. The step of calculating features of the ROI comprises providing the image of region of interest (ROI) (step 501), calculating the size of the ROI (step 502), calculating properties of the image, such as image moments, Hu moments or other similar properties (step 503), and calculating the position relative to original image (step 504). Parameters and properties like size, Hu moments and absolute co-ordinates are calculated and will be used in later stage for comparison (in step 205).

1. A visual cross-browser testing method for testing web pages and web applications in a computer system, the method comprises the steps of:
providing a baseline image of a web page rendered by a baseline browser;
extracting baseline image features from said baseline image;
providing a test image of the web page rendered by browser under test; extracting the test image features from said test image;
comparing the baseline image features and the test image features;
marking up the regions with differences of the test image; and
visualizing the regions with differences on said test image.

2. A method according to claim 1, wherein the visualizing the regions with differences comprises representing the regions with differences as transparent draggable window on said test image.

3. A method according to claim 1, wherein the visualizing comprises representing the regions with differences as colored box on said test image.

4. A method according to claim 1, wherein the steps of extracting features further comprises providing a rendered bitmap image representing a web page, finding the regions of interest of said bitmap image, said regions of interest comprising graphic elements relevant for visual testing, calculating specific set of parameters for each region of interest and saving each region of interest.

5. A method according to claim 4, wherein the step of determining the regions of interest comprises calculating corner features, determining regions comprising a corner, joining neighboring regions comprising corners into regions of interest and calculating bounding co-ordinates for regions of interest.

6. A method according to claim 5, the step of calculating features of the region of interest comprises providing the image of region of interest, calculating the size of the region of interest, calculating image moments and calculating position of the image relative to original image.

7. A system for cross-browser testing of web pages and web applications, the system comprising:
a web renderer, comprising a plurality of virtual machines, each of said virtual machines adapted to run an operating system and a browser for rendering a test web page and capturing a test image of said test web page;
an image comparer for comparing said images captured by said plurality of virtual machines with a baseline image and detecting differences between said test images, and said baseline image; and
a result server for generating a graphical user interface and outputting said differences on said graphical user interface, wherein each of said web renderer, said comparer and said result server connected to each other over a computer network.

8. A system according to claim 7, wherein said result server is adapted to show each of said test images captured by said plurality of virtual machines as thumbnails with differences highlighted compared to said baseline image.

9. A system according to claim 8, wherein said result server is adapted to show a full size test image with said differences from said baseline image as highlighted or as transparent or colored boxes.
